(19) United States
(12) Patent Application Publication
(10) Pub. No.: US 2009/0181769 A1
(43) Pub. Date: Jul. 16, 2009

(54) System and method for 3d image manipulation in gaming machines

(76) Inventors: Alfred Thomas, Las Vegas, NV (US); Ryan Summers, Elk Grove Village, IL (US)

Correspondence Address: SCHWEGMAN, LUNDBERG & WOESSNER/WMS GAMING, P.O. BOX 2938, MINNEAPOLIS, MN, 55402, US

(21) Appl. No.: 11/664,180

(22) PCT Filed: Sep. 27, 2005
(86) PCT No.: PCT/US05/34545

§ 371 Date: Mar. 29, 2007

Related U.S. Application Data
(60) Provisional application No. 60/615,151, filed on Oct. 1, 2004.

(51) Int. Cl. A63F 13/00

(52) U.S. Cl. 463/32

(57) ABSTRACT

Embodiments include a user interface method in a gaming machine that produces a gaming outcome. The user interface method includes displaying a virtual control; detecting a movement by the user, translating the movement into movement of the virtual control; and determining the gaming outcome as a function of movement of the virtual control.

### RELATED APPLICATION

This application claims the priority benefit of U.S. Provisional Application Ser. No. 60/615,151 filed Oct. 1, 2004, the contents of which are incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2003, WMS Gaming, Inc. All Rights Reserved.

### BACKGROUND OF THE INVENTION

1. Field of the Invention

This patent application pertains generally to gaming systems, and more particularly, but not by way of limitation, to a system and method for employing virtual controls in a gaming machine.

2. Background Information

Video gaming machines are popular within the gaming industry. They typically are operable to play traditional games such as slots, poker, bingo, keno and blackjack. Such machines have been and continue to be enhanced by adding features that make them more attractive, exciting and entertaining.

The graphical capabilities of processors have increased dramatically over the last decade. At the same time, there is a continuing need to develop new and exciting effects for video gaming machines. What is needed is a way of harnessing the graphics power of processors to introduce new and innovative features in video gaming machines.

### BRIEF DESCRIPTION OF THE DRAWINGS

FIG. 1 illustrates a gaming machine according to the present invention;

FIG. 2 is a block diagram of a control system suitable for operating the gaming machine of FIG. 1;

FIG. 3 illustrates a virtual control according to the present invention; and

FIG. 4 illustrates a method of controlling the gaming machine according to the present invention.

### DETAILED DESCRIPTION OF THE INVENTION

In the following detailed description of the preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

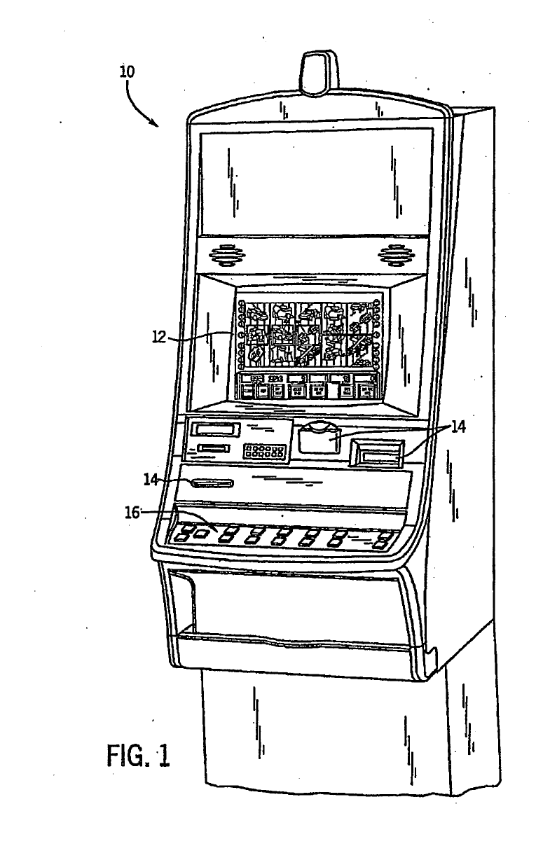

FIG. 1 illustrates an exemplary video gaming machine 10, also referred to as a Video Lottery Terminal (VLT), in which embodiments of the invention may be implemented. In some embodiments, gaming machine 10 is operable to conduct a wagering game such as mechanical or video slots, poker, keno, bingo, or blackjack. The gaming machine 10 shown in FIG. 1 includes a video display 12 such as a cathode ray tube (CRT), liquid crystal display (LCD), plasma, or other type of video display known in the art. In one such embodiment, a touch screen overlies the display 12. In the illustrated embodiment, the gaming machine 10 is an “upright” version in which the display 12 is oriented vertically relative to a player.

Alternatively, the gaming machine may be a “slant-top” version in which the display 12 is slanted at about a thirty-degree angle toward the player.

Gaming machine 10 includes one or more credit receiving mechanisms 14 for receiving credits to be used for placing wagers in the game. The credit receiving mechanisms 14 may, for example, include a coin acceptor, a bill acceptor, a ticket reader, and a card reader. The bill acceptor and the ticket reader may be combined into a single unit. The card reader may, for example, accept magnetic cards and smart (chip) cards coded with money or designating an account containing money. In some embodiments, credit receiving mechanism 14 receives credits through a network interface.

In some embodiments, the gaming machine 10 includes a user interface comprising a plurality of push-buttons 16, the above-noted touch screen, and other possible devices. The plurality of push-buttons 16 may, for example, include one or more “bet” buttons for wagering, a “play” button for commencing play, a “collect” button for cashing out, a “help” button for viewing a help screen, a “pay table” button for viewing the pay table(s), and a “call attendant” button for calling an attendant. Additional game specific buttons may be provided to facilitate play of the specific game executed on the machine. The touch screen may define touch keys for implementing many of the same functions as the push-buttons. Other possible user interface devices include a keyboard and a pointing device such as a mouse or trackball.

A processor controls operation of the gaming machine 10. In response to receiving a wager and a command to initiate play, the processor randomly selects a game outcome from a plurality of possible outcomes and causes the display 12 to depict indicia representative of the selected game outcome. In the case of slots for example mechanical or simulated slot reels are rotated and stopped to place symbols on the reels in visual association with one or more pay lines. If the selected outcome is one of the winning outcomes defined by a pay table, the processor awards the player with a number of credits associated with the winning outcome.

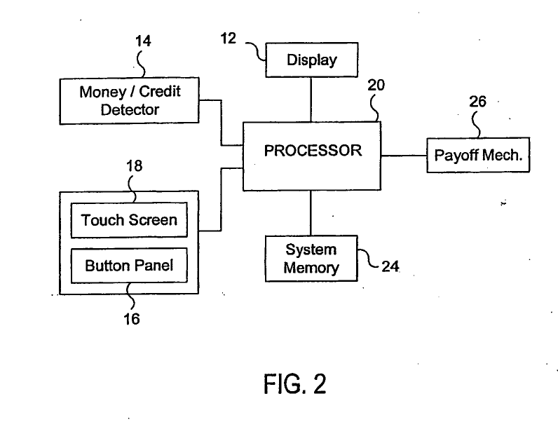

FIG. 2 is a block diagram of a control system suitable for operating the gaming machine 10. Money/credit detector 22 signals a processor 20 when a player has inserted money, tickets, tokens, cards or other mechanism for obtaining credits for plays on the gaming machine through credit mechanisms 14. Using a button panel 16 and/or a touch screen 18, the player may select any variables associated with the wagering game and place his/her wager to purchase a play of the game. In a play of the game, the processor 20 generates at least one random event using a random number generator (RNG) and provides an award to the player for a winning outcome of the random event.

Alternatively, the random event may be generated by a remote computer using an RNG or pooling schema and then transmitted to the gaming machine. The processor 20 operates the display 12 to represent the random event(s) and outcome(s) in a visual form that can be understood by the player. In addition to the processor 20, the control system may include one or more additional slave control units for operating the display 12 and any secondary displays.

System memory 24 stores control software, operational instructions and data associated with the gaming machine. In one embodiment, the system memory 24 comprises a separate read-only memory (ROM) and battery-backed random-access memory (RAM). However, it will be appreciated that the system memory 24 may be implemented on any of several alternative types of memory structures or may be implemented on a single memory structure.

A payoff mechanism 26 is operable in response to instructions from the processor 20 to award a payoff to the player. The payoff may, for example, be in the form of a number of credits; The number of credits is determined by one or more math tables stored in the system memory 24.

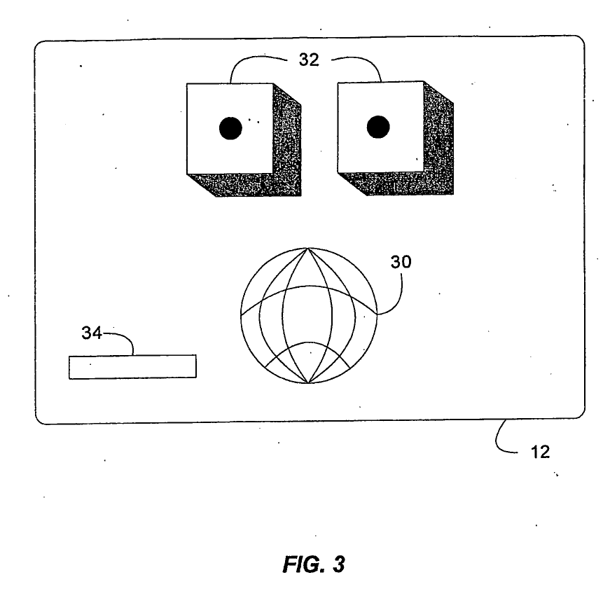

In one embodiment, gaming machine 10 includes three-dimensional virtual controls such as shown in FIG. 3.

Three dimensional effects have been used in previous gaming machines. Effects to date have, however, relied on pre-rendered presentations of three-dimensional images. The use of pre-rendered images limited the types of user interaction that could be handled and, therefore, was view as somewhat gimmicky. Gaming machines 10 according to the present invention generate their three-dimensional effects in real-time. The result is a much more interactive and interesting environment for the gaming player.

In one embodiment, the three-dimensional virtual controls are implemented using a game design package such as RenderWare Studio 2.0 running, for example, on a processor designed by Intel or AMD.

In one embodiment, a player uses a virtual control 30 to impart a force to an object 32 such as a ball or one or more die. The virtual control can be used to determine parameters (such as velocity, direction, and duration) that can be used to decide the outcome of either virtual or mechanical game play mechanics. Some representative virtual controls include trackballs, levers and pinball controls. In one embodiment, the user moves his or her finger within the apparent area of control 30 in touch screen 18 to actuate virtual control 30. In another embodiment, the user moves his or her finger within an area 34 in touch screen 18 to actuate virtual control 30.

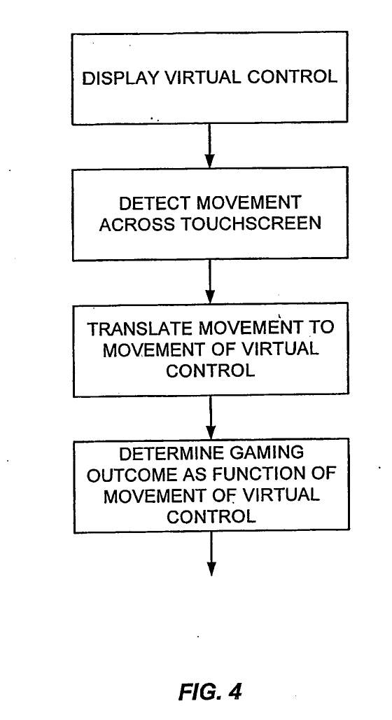

In one embodiment, such as is illustrated in FIGS. 3 and 4, processor 20 displays a virtual control trackball 30 at 40 and waits to detect movement on a user input such as touch screen 18 or button 16. When movement is detected at 42, control moves to 44, where the movement detected is translated into movement of the virtual control. Control then moves to 44 where the game outcome is determined as a function of the movement of the virtual control.

In one embodiment, virtual trackball 30 is used to rotate dice, either on screen or on a mechanical top box, as the trackball is moved. When the trackball is moved with high enough of a velocity, the dice are thrown at the speed and direction the player spun the trackball . Such an approach gives the player the control they feel is lost by computer-driven dice mechanics.

In one embodiment, virtual control provides variable-strength input where the player determines not only an angle to aim, but the strength as well. An approach similar to the game mechanic of console golf games can be used, where the player determines the direction to shoot, then decides how hard to hit the ball. In one embodiment, a power indicator is used to indicate power to be imparted. In another embodiment, a spring representation similar to the mechanical action of a pinball actuator is used.

In one embodiment, players select items and place them into specific spots of the environment/background, or into a specific character's hands. This could allow players to take pre-defined parts and assemble them in any fashion they see fit. One could build custom-Pachinko boards, Rube Goldberg machines, or your own hot rod. Using real-time physics, the creation is then tested or played.

In one embodiment, variable strength input is used to make the game operate in a more intuitive, fuzzy manner. This is done, for instance, by allowing the player to select an object, pull back, and release. This can be done by emulating the use of a slingshot, a bowling ball, or a catapult on display 12 and actuating control 30 by pulling back with your finger still on the screen, and releasing to release or fire.

In one embodiment, display 12 includes user-defined Resolution, in which a player can adjust type and reel symbol size on the fly. This could be used, for example, to make the reels in a reel-based game appear larger for those players with impaired vision. In one such embodiment, display 12, button 16 or touch screen 18 include an button or other mechanism used to enable or disable this mode. Players who never use the on-screen buttons can, for example, enable an expert mode, freeing up the bottom area of the screen for more instructions, animations, or larger reels.

In some embodiments, the effects of using virtual controls in a gaming machine are enhanced via real-time lighting effects. For instance, in one embodiment, real-time lighting is used to enhance the reality of the reel screens, reflecting events initiated by the physical cabinet and top box. If a light goes off on the top box, the same light bleeds into the reel screen, affecting the art. In another embodiment, virtual spotlights displayed on display 12 are synched up with lights in the cabinet.

In another embodiment, real-time lighting is combined with texture-swapping in order to enable a persistent-state game to reflect the time of day the player is experiencing. Characters outfits can, for instance, change from pajamas to a suit-and-tie, or certain bonuses can occur more often at specific times of day.

In yet another embodiment, real-time lighting is used in conjunction with Click-and-Drag play mechanics to open up new possibilities for picking games. In one such embodiment, a Treasure Hunter character in a bonus round explores a dimly lit cave with a flashlight. Players direct the flashlight by, for instance, dragging around a virtual flashlight with their fingertip, illuminating as much treasure as they can in a given amount of time. In one such embodiment, the flashlight is given a limited battery light and that is reflected in the light cast as the battery power drains away.

In yet another embodiment, lights on the screen change to reflect an event occurring outside gaming machine 10. A jackpot on the gaming machine next to gaming machine 10 displays a light display connected to a jackpot win and the light shows up on display 12 of gaming machine 10. Real-time calculations allow processor 20 to do this even while the virtual reels are spinning.

Texture swapping can also be used to enhance the game experience. In one embodiment, texture swapping is used to customize backgrounds, interfaces, and reels. For instance, reel symbols and info text are customized to specific casinos, with logos or advertisements tailored to their needs. This texture swapping is performed on the fly, rather than relying on precalculated and, therefore, limited images. This approach could also be used to display advertisements based on the time of day, activities the casino wants to foster, etc.

In the above discussion, the term “processor” is defined to include any digital or analog data processing unit. Examples include any microprocessor or microcontroller capable of embodying the inventions described herein.

Examples of articles comprising machine readable media are floppy disks, hard drives, CD-ROM or DVD media or any other read-write or read-only memory device.

Portions of the above description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. In a gaming machine that produces a gaming outcome, a user interface method, comprising:
displaying a virtual control;
detecting a movement by the user;
translating the movement into movement of the virtual control; and
determining the gaming outcome as a function of movement of the virtual control.

2. The user interface method of claim 1, wherein the virtual control moves an image displayed on the gaming machine.

3. The user interface method of claim 2, wherein movement of the virtual control matches movement of the image displayed on the gaming machine.

4. The user interface method of claim 1, wherein a user selects virtual items and places the items into specific spots of a virtual environment or background.

5. The user interface method of claim 2, wherein virtual control includes variable strength input.

6. An article comprising a machine readable medium having instructions thereon, wherein the instructions, when executed in a computer, create a system for executing the method of claim 1.

7. An article comprising a gaming machine capable of performing the method of claim 1, the gaming machine comprising a display and a touch screen that overlays the display.

8. The article of claim 7, wherein the gaming machine is oriented vertical relative to a player.

9. The article of claim 7, wherein the gaming machine is slanted toward the player.

10. The article of claim 7, wherein the gaming machine includes three-dimensional virtual controls.

11. The article of claim 10, wherein the three-dimensional virtual controls generate three-dimensional effects in real time.

12. The article of claim 10, wherein the virtual controls include a power indicator indicating power to be imparted.

13. The article of claim 10, wherein the virtual controls include a spring representation, corresponding to a mechanical action.

14. The article of claim 10, wherein virtual controls include real-time lighting effect.

15. An article comprising a gaming machine capable of performing the method of claim 1, the gaming machine comprising a display and a keyboard and a pointing device.

16. In a gaming machine that produces a gaming outcome, a user interface method, comprising:
displaying a plurality of objects;
displaying a virtual control;
detecting a movement by the user;
translating the movement into movement of the virtual control;
rotating one or more of the plurality of objects as a function of movement of the virtual control; and
determining the gaming outcome as a function of movement of the one or more objects within the display.

17. The method of claim 16, wherein displaying a plurality of objects includes projecting a texture on the objects.

18. An article comprising a machine readable medium having instructions thereon, wherein the instructions, when executed in a computer, create a system for executing the method of claim 16.
